(19) United States
(12) Patent Application Publication
(10) Pub. No.: US 2013/0077856 A1
(43) Pub. Date: Mar. 28, 2013

(54) PROCESSES AND SYSTEMS FOR TRAINING MACHINE TYPESETS FOR CHARACTER RECOGNITION

(71) Applicant: Andrew Frank Ferro, West Chester, OH (US)

(72) Inventor: Andrew Frank Ferro, West Chester, OH (US)

(73) Assignee: GENERAL ELECTRIC COMPANY, Schenectady, NY (US)

(21) Appl. No.: 13/341,210

(22) Filed: Dec. 30, 2011

Related U.S. Application Data
(60) Provisional application No. 61/538,564, filed on Sep. 23, 2011.

(51) Int. Cl. G06K 9/62

(52) U.S. Cl. 382/159

(57) ABSTRACT

Processes and systems for training machine vision systems for use with OCR algorithms to recognize characters. Such a process includes identifying characters to be recognized and individually generating at least a first set of templates for each of the characters. Each template comprises a grid of cells and is generated by selecting certain cells of the grid to define a pattern that correlates to a corresponding one of the characters. Information relating to the templates is then saved on media, from which the information can be subsequently retrieved to regenerate the templates. The templates can be used in an optical character recognition algorithm to recognize at least some of the characters contained in a marking.

### CROSS REFERENCE TO RELATED APPLICATIONS

This application claims the benefit of U.S. Provisional Application No. 61/538,564, filed Sep. 23, 2011, the contents of which are incorporated herein by reference.

### BACKGROUND OF THE INVENTION

The present invention generally relates to imaging technologies and their use. More particularly, this invention relates to machine vision (MV) imaging methods and equipment that are capable of use with object character recognition (OCR) algorithms employed in image-based processes and equipment, for example, of the type used in monitoring, inspection and/or control applications.

Machine vision (MV) generally refers to the use of image sensing techniques to acquire (“read”) visual images and convert the images into a form from which a computer can extract data from the images, compare the extracted data with data associated with previously developed standards, and then generate outputs based on the comparison that can be useful for a given application. As nonlimiting examples, such applications can include the identification of parts, the detection of flaws, the location of parts in three-dimensional space, etc. The field of machine vision systems generally encompasses OCR equipment and algorithms. A nonlimiting example is the recognition (“reading”) of a series of characters associated with a manufactured article, for example, a part marking including serial numbers, part numbers, vendor codes, etc. Characters used in part markings (and numerous other applications) are not limited to numbers, but often include alphanumeric characters that are considered to be human-readable, and/or symbols that might not be considered to be human-readable, including but not limited to one and two dimensional data matrix barcodes.

Machine vision systems utilizing OCR equipment and algorithms generally identify a marking on an article by acquiring from the article an image containing the marking, and then comparing the acquired image to stored typeset templates in order to identify individual characters in the acquired image. The templates are typically trained with previously acquired image data, in which case many templates can map to a single character. FIG. 1 represents a vision system 10 for performing such a process as including the identification of application-specific parameters and then acquisition of training images, for example, from characters of a part marking 12, from which templates 14 are generated. These steps are often performed by an application engineer, who stores the templates 14 in a suitable storage device 16. Each template 14 for a given character corresponds to the physical extent of that character, referred to herein as an image space. Because of the likelihood for variations in scale, lighting conditions, surface finishes, etc., sufficient training images must be acquired to develop multiple templates 14 for each character that is to be recognized by the vision system 10. An off-the-shelf OCR algorithm can then be used to perform character recognition by comparing images acquired on-line (for example, from manufactured articles) with the stored templates 14 for character recognition. With this type of process, each vision system 10 must be trained for a particular application and its application-specific parameters.

The manner of training entailed by the approach represented in FIG. 1 may result in under-training if, for example, a particular character has not been previously seen and imaged, and may result in over-training if a character has been trained multiple times with various artifacts or noise embedded. Furthermore, the use of acquired image data to train an OCR algorithm produces typeset templates 14 whose quality is dependent on nearly constant imaging conditions, such as zoom scale, lighting conditions, surface finishes, and the like.

There are incentives for pursuing off-the-shelf, rapid prototyping vision systems in machine vision applications because of the imaging suites the former provide, which facilitates setting up inspections for common tasks. However, training typesets can be a daunting task because representative examples of each character are required, sometimes requiring multiple examples of the same character in the presence of noise, artifacts, or geometrical variation. The need for repetitive character training is particularly an issue in situations intended for widespread or generic applications, such as reading different manufactured articles that may have different geometries, or reading the articles under different lighting conditions, zoom scales, etc. The drawback to repetitive training is over-training, where specific features of a character can become distorted or even lost as each example character with different anomalies is added to the set defining a single character.

In view of the above, it should be appreciated that there is an ongoing need for OCR systems capable of overcoming shortcomings encountered with existing OCR training methodologies. In particular, it would be advantageous if a simplified training methodology existed that improved accuracy during the reading process. It would be further advantageous to provide an OCR training methodology independent of the end use application.

### BRIEF DESCRIPTION OF THE INVENTION

The present invention provides processes and systems for training machine vision systems for use with OCR algorithms to recognize characters.

According to a first aspect of the invention, a process is provided that includes identifying characters to be recognized, and individually generating at least a first set of templates for each of the characters. Each template comprises a grid of cells and is generated by selecting certain cells of the grid to define a pattern that correlates to a corresponding one of the characters. Information related to the shape of each template is then saved on media from which the information can be retrieved. The templates can be subsequently regenerated by retrieving the information from the media and exported for use in an optical character recognition algorithm to recognize at least some of the characters contained in a marking.

According to a second aspect of the invention, a system for performing character recognition includes means for individually generating at least a first set of templates for each of a plurality of characters, media adapted for saving the templates and from which the templates can be retrieved, and an optical character recognition algorithm adapted to use the templates to recognize at least some of the characters contained in a marking. Each template comprises a grid of cells and is generated by selecting certain cells of the grid to define a pattern that correlates to a corresponding one of the characters.

A technical effect of the invention is the ability to generate templates that are essentially noiseless and artifact-free and can be associated with certain typesets or fonts, such that training of an OCR algorithm is only necessary once per typeset or font, instead of being performed for each unique OCR application. As a result, separate sets of templates can be readily adapted for use in multiple applications that use the same typeset or font, but whose characters are read under different conditions that would complicate the use of conventional OCR machine vision systems. Because the templates are not generated from the image source, they are free of distortions, lighting imperfections, surface texture, and other specific application anomalies. This methodology provides the most general templates for an OCR algorithm to use for correlation against a wide host of applications that use the trained typeset. Another advantage is that the templates can be used to train an OCR algorithm outside of an on-line process by someone separate from the end applications, and in so doing are capable of increasing the speed and efficiency of the character recognition training process.

Other aspects and advantages of this invention will be better appreciated from the following detailed description.

### BRIEF DESCRIPTION OF THE DRAWINGS

FIG. 1 illustrates a machine vision system that uses a prior art OCR training process to identify characters.

FIG. 2 schematically represents an example of a template that can be used in combination with a machine vision system to identify characters in accordance with embodiments of the invention.

FIG. 3 represents a part marking on a turbine blade and readable using an on-line machine vision reading process.

FIG. 4 represents individual templates similar to that of FIG. 2 and generated for each of the characters of the marking shown in FIG. 3.

FIG. 5 provides an exemplary flow chart of an off-line template-generating process and an on-line character reading process that can be performed with the use of templates similar to FIG. 2.

FIG. 6 schematically represents an off-line template-generating system capable of use in the off-line training process of FIG. 5.

FIG. 7 illustrates a machine vision system that uses the off-line template-generating system of FIG. 6 in an OCR training process to identify characters.

### DETAILED DESCRIPTION OF THE INVENTION

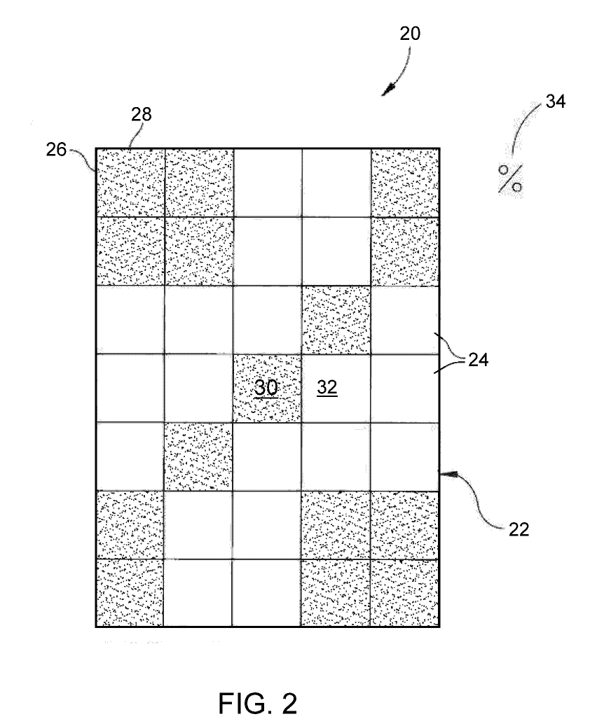

The following describes embodiments of machine vision systems and methods of operating such systems to produce outputs that can be used with OCR algorithms to recognize characters, for example, characters of a part marking on an article. FIG. 2 represents an example of a template 20 that can be employed by the present invention to recognize characters, a nonlimiting example of which is the percentage sign (%) 34 in FIG. 2. The template 20 is configured as a grid 22 of cells 24 arranged in rows 26 and columns 28. As evident from FIG. 2, some of the cells 24 are “on” (shaded) 30 and others are “off” 32, with those cells 24 that are “on” corresponding to the shape of the percentage sign 34. As such, the status of the cells 24 as “on” or “off” constitutes data representative of a particular character. If the marking is formed with a machine that imprints (peens) dots on an article to form a character, each cell 24 may represent a single dot of the dot peen grid that defines the character, and the template 20 can be a manifestation of a cell grid 22 formed by up-sampling the dot peen grid to the same resolution as the character image.

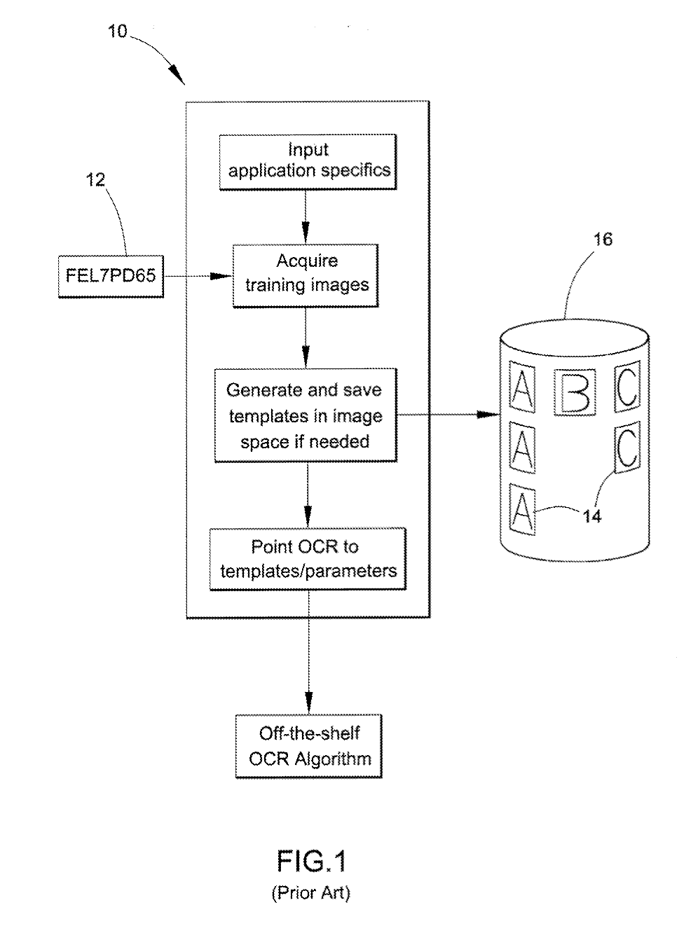

According to a preferred aspect of the invention, the grid 22 and its cells 24 effectively constitute information relating to the shape of a template 20 for a character, and this information can be generated in an off-line process by which a separate template 20 is formed for each character desired to be read for any number of applications. As opposed to the prior art practice of acquiring multiple training images to train machine vision systems at an on-line “application” level, as is required by the prior art system 10 of FIG. 1, the information that represents the template 20 can be created at an off-line “system” level. More particularly, the information can be generated off-line by identifying which characters are or might be used in the one or more applications for which the template 20 might be used, and then selecting patterns of “on” and “off” cells 24 that are capable of being individually correlated to the identified characters. The array of cells 24 for each template 20 defines what is referred to herein as a “grid space” defined by the rows 26 and columns 28 of the array. For a given character, the size of the array (and, therefore, the number of cells 24 in the template 20) can be limited to the smallest size necessary to characterize the data for the characters of interest. Simultaneously, the on-off format of the template 20 can be utilized to create the highest contrast in the given grid space. In the example of FIG. 2, an array of 5×7 cells 24 is sufficient to define the grid space of the template 20 for the percentage symbol 34, though it should be understood that smaller and larger arrays are foreseeable. In any case, the pattern of “on” cells 24 embodies the resolution of the character, as opposed to the resolution of images acquired to generate the templates 14 of the conventional machine vision system of FIG. 1. As will be discussed in reference to FIGS. 5 through 7, following the generation of the desired number of templates 20 for the intended application or applications, the information relating to the templates 20 can be stored for later use in an on-line machine vision character reading process.

Because characters are defined in a grid space instead of the image space of FIG. 1, templates 20 can be developed and used for essentially any application involving the same typeset or font. More particularly, templates 20 defined by grid spaces are not limited to certain applications as are image space templates, which must take into account specific environmental factors that may exist for each particular application. As will be discussed below, though different sets of templates 20 may be developed for use in applications having different typesets or fonts, the typeset development and resulting templates 20 are otherwise independent of the end use application.

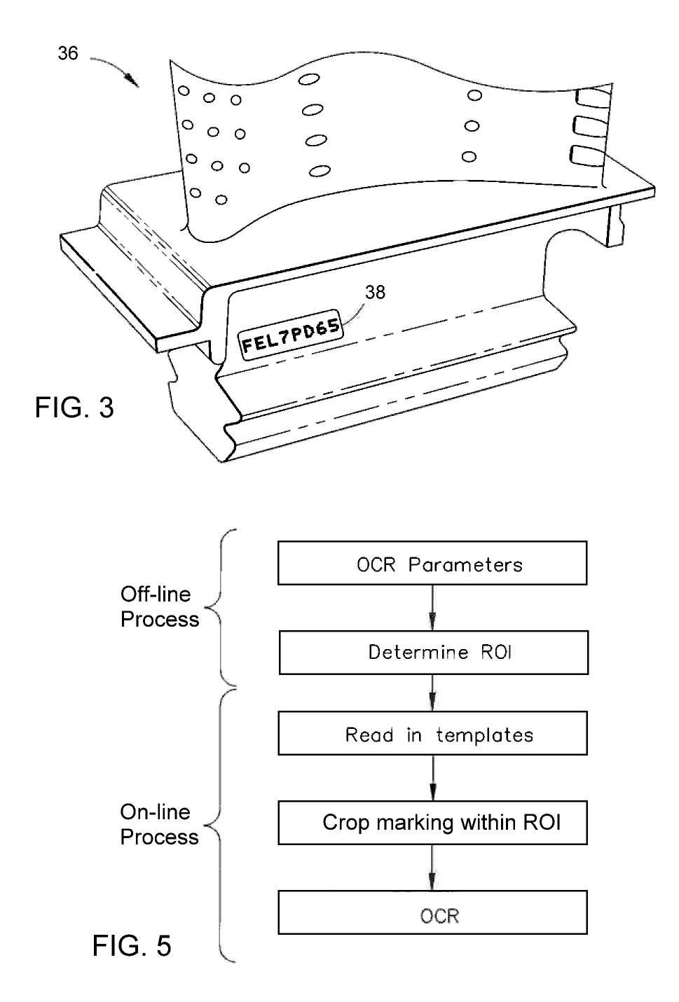

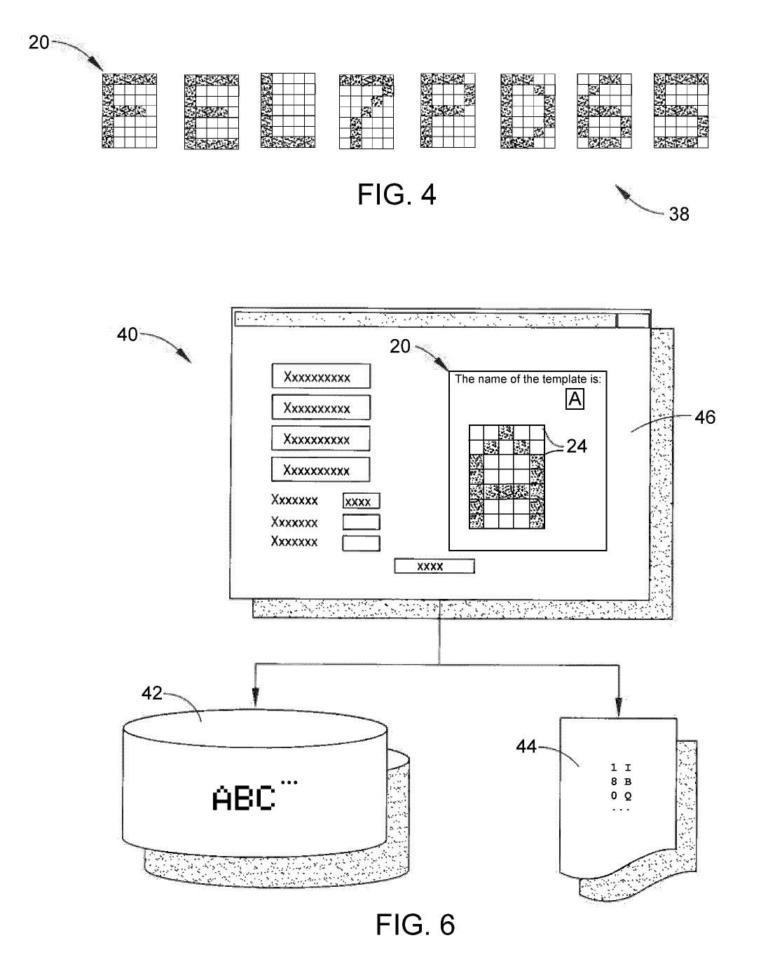

FIG. 3 schematically represents the root end of a turbine blade 36, on which an exemplary part marking (for example, a serial number, part number, vendor code, etc.) 38 has been stamped or otherwise created, and whose individual characters can be read during processing, inspection, or some other on-line process performed on the blade 36. FIG. 4 schematically represents templates 20 generated for each of the characters of the marking 38. Though the marking 38 is represented as comprising only alphanumeric characters (and therefore considered to be human-readable), the invention can also be employed with essentially any series of characters, including symbols or other characters that may be considered as not human-readable, including but not limited to one and two dimensional data matrix barcodes. As evident from FIG. 4, each of the characters can be defined by a template 20 comprising a grid space of 5×7 cells 24 though, again, a fewer or greater number of cells 24 could be used. As previously noted, the templates 20 can be defined off-line at the system level, and then later generated and used online by an OCR algorithm to recognize characters at the application level.

In addition to the templates 20, other inputs may be desired for use by the OCR algorithm. For example, certain information can be calculated or derived from the information that represents the templates 20 and made available as outputs for use by the OCR algorithm. Nonlimiting examples include “Look Up Tables” (LUT) for the purpose of defining similar templates, LUTs for defining specific similar regions within templates, LUTs for template spacing, LUTs for scale and tolerance, and any other OCR specific inputs that can be readily and automatically generated with the knowledge of the information contained in the template morphologies. As will be better understood from a discussion below of FIG. 6, these additional inputs can be used to help train the OCR algorithm to better correlate images that are read with particular character templates 20. The off-line process that defines the templates 20 can easily output these additional inputs because it has the information relating to the shape of each character at the most fundamental scale, namely, the grid space.

FIG. 5 represents the off-line stage of the invention as including the step of determining OCR parameters for a particular marking (such as the marking 38 of FIGS. 3 and 4), during which templates 20 are generated and the sets of information that define the templates 20 are stored for each character of interest for the marking to be read. FIG. 5 represents an additional step in which a region of interest (ROI) is determined for articles, for example, within the image of the blade 36, from which characters are to be read. As part of an off-line process, these steps can be repeated to create separate sets of templates 20 for any number of marking systems that may utilize a different typeset or font. FIG. 5 further represents an on-line or application level that utilizes the outputs of the template-generating off-line process of the invention. The on-line process is represented as including the steps of reading the appropriate set of templates 20, using the region of interest to crop the marking in order to avoid unnecessarily reading regions of the article that do not carry the marking of interest, and then using the templates 20 in an OCR algorithm to read and identify the characters of the marking. Aside from using the outputs of the template-generating off-line process of the invention, the on-line process of FIG. 5 is representative of the operation of an off-the-shelf OCR algorithm. The OCR algorithm uses a correlation technique to compare an image of the marking 38 against the templates 20 to generate digital manifestations of characters recognized from the marking 38.

As represented in FIG. 6, the information relating to the shapes of the templates 20 can be generated through the use of an off-line system 40 and then stored in a template database on a suitable storage device 42 that can be accessed by the OCR algorithm. As evident from FIG. 6, a screen image of a template 20 can be displayed on a screen 46 of a personal computer or other suitable processing apparatus, from which the user can select individual cells 24 to define the “on” cells capable of uniquely identifying a character to be recognized. This step is repeated for each character that might be read in the one or more applications in which character recognition is to be performed. The benefits of the off-line template generation method of this invention can be readily appreciated from a comparison between the clean grid space of the template 20 in FIG. 6 with the templates 14 of the conventional machine vision system of FIG. 1.

Any other inputs desired for use by the OCR algorithm may also be stored on the storage device 42. In addition, certain information can be calculated or derived from the data contained in the templates 20 and made available for use by the OCR algorithm. For example, FIG. 6 represents the inclusion of a “Look Up Table” (LUT) 44 that can be generated for characters that have similar templates 20, for example, the number “1” and the upper case letter “I.” The OCR algorithm can be trained to correlate each image that is read within the region of interest with a character template 20, analyze every pixel of the read image, and generate an output correlation score for every pixel within the region of interest. High correlation denotes recognition of the character that has been read. The OCR algorithm can also be taught to refer to the Look Up Table 44 to improve correlation scores. For instance, the LUT 44 may provide information about what areas of the templates 20 are identical, so that the OCR algorithm can mask those areas out to improve a correlation score difference that otherwise would have been too close to make a decision. Therefore, the OCR algorithm may use an iterative process to correlate the read image to a character of a stored template 20, as well as utilize other inputs that might be useful to the training process.

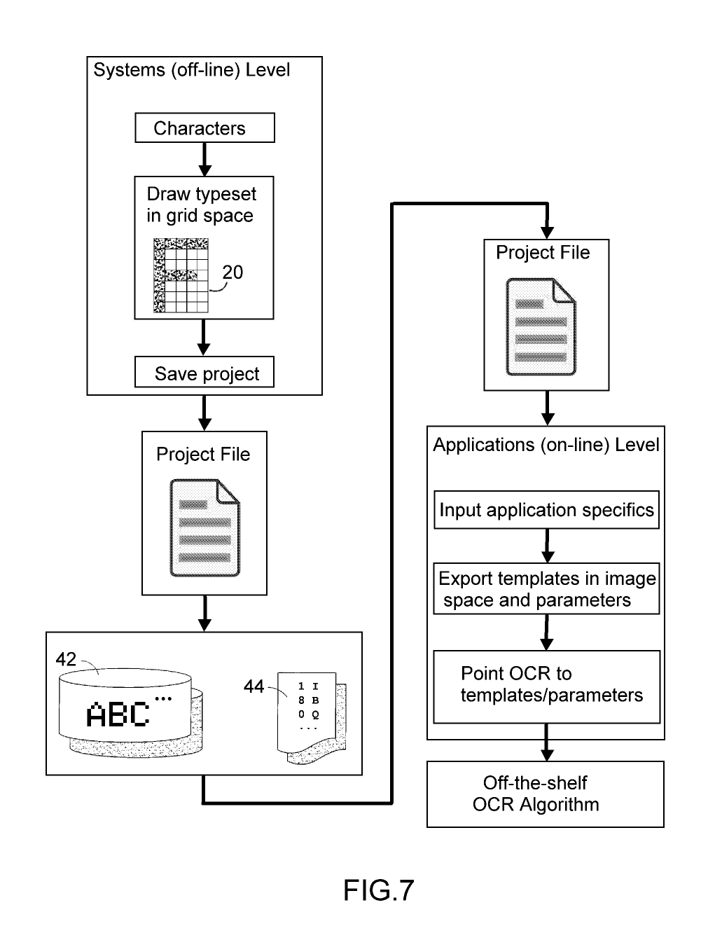

As previously noted, different sets of templates 20 may be developed for use in applications that employ different typesets or fonts. For example, the templates 20 can be developed for different typesets or fonts, and the different templates 20 stored in separate project files on the storage device 42. Furthermore, templates 20 can be scaled (zoom in/out) for the purpose of translating a template 20 in grid space to an image coupon in image space for input into the OCR algorithm (identified as “application specifics” in FIG. 7). For example, for a grid space of 5×7 cells, a zoom scale of 5.0 can be used to generate with each template 20 a 25×35 pixel image. Similarly, non-integer zoom scales could be utilized for translating a template 20 from grid space to image space, such that correlations made by the OCR algorithm would match as closely as possible to the image acquired in each respective application the algorithm is employed. It is assumed here that the OCR algorithm may require templates 20 to be at the identical resolution and zoom scale with which the image has been acquired.

FIG. 7 represents a flow chart that is similar to the prior art flow chart of FIG. 1, but modified to illustrate certain aspects of the invention. FIG. 7 again represents certain steps as being performed off-line at the system level of an inspection process, and other steps performed on-line at the application level of the inspection process. In the off-line process, the characters that will need to be recognized for the one or more applications of interest are identified, and a template 20 for each of these characters is “drawn,” for example, on the screen display 46 of FIG. 6. As previously mentioned, separate sets of templates 20 can be generated and stored as separate projects on the storage device 32. Look up tables 44 can also be generated for each project and its set of templates 20. As previously noted, the use of look up tables 44 is not meant to be all-inclusive, but rather just one example of OCR-dependant input parameters that can be generated within the off-line process of this invention. Other OCR-dependant inputs which can be derived from the templates in grid space can also be generated. Users can generate the appropriate templates 20 and save them on the storage device 42 for subsequent use on-line by inputting application specifics corresponding to the particular application. The appropriate templates 20 are then exported in image space, meaning that they are resampled to the same resolution and zoom scale as that which is expected in the image, after which characters of interest are read and the OCR algorithm operates to recognize the characters.

Because the templates 20 can be organized in project files associated with certain typesets or fonts, training of the OCR algorithm is only necessary once per typeset or font, instead of being performed for each unique application as would be required for the prior art system 10 of FIG. 1. Furthermore, training of the OCR algorithm can occur outside of the on-line process of an inspection process. Accordingly, a significant benefit is that the off-line process reduces the engineering touch time per application for the process of training the OCR algorithm and increases the speed, the efficiency and, most importantly, the accuracy of a machine vision system, whose output can be used by an otherwise standard on-line OCR algorithm. Another benefit is that, because training of the OCR algorithm occurs off-line, the templates 20 can be more readily adapted for use in multiple other applications that use the same typeset or font, but whose characters are read under different conditions that might complicate the use of a conventional system of the type represented in FIG. 1.

Prior art training methodologies of the type represented in FIG. 1 also rely on seeing multiple examples of the same character in order to increase the chance of correlating an image with varying environmental effects to that of templates seen previously. This can lead to over-training, where specific and subtle features of a character can be lost. This problem is solved with the present invention through the use of templates 20 that are free of environmental effects from the beginning and can provide the OCR algorithm with exactly one example template 20 for each character. The prior art training methodology in FIG. 1 also relies on seeing an example of the character at least once. If this is not possible before the template set is released in on-line mode, then it is subject to under-training, where the OCR algorithm will fail when it sees a character for the first time, or sees one with environmental effects that do not correlate with any of the previous example template. The present invention solves this problem by allowing a user at the system level to train an entire character set off-line. The prior art training methodology in FIG. 1 also relies on seeing multiple characters in string form while within the training process in order to train character spacing information into the OCR algorithm. For the same reasons stated above, the present invention solves this issue by allowing the user at the system level to train this spacing into grid space, and on the fly, embedding that information into the typeset attributes for a single typeset.

While the invention has been described in terms of specific embodiments, it is apparent that other forms could be adopted by one skilled in the art. For example, physical configurations of the hardware and software used to construct a machine vision system could differ from what is described or shown above. Therefore, the scope of the invention is to be limited only by the following claims.

1. A process of training machine typesets for character recognition, the process comprising:
identifying characters to be recognized;
individually generating at least a first set of templates for each of the characters, each of the templates comprising a grid of cells and each template being generated by selecting certain cells of the grid to define a pattern that correlates to a corresponding one of the characters;
saving information related to the shape of each template on media from which the information can be retrieved;
retrieving the information from the media;
regenerating the templates from the information; and
exporting the templates for use in an optical character recognition algorithm to recognize at least some of the characters contained in a marking.

2. The process according to claim 1, wherein the steps of identifying the characters, generating the templates, and saving the templates are performed off-line in an inspection process.

3. The process according to claim 1, wherein the steps of retrieving and using the templates are performed on-line in an inspection process.

4. The process according to claim 1, wherein the step of generating the templates is performed by displaying the grid on a screen and selecting the cells from the screen.

5. The process according to claim 1, wherein the step of generating the first set of the templates is performed for a single typeset or font.

6. The process according to claim 5, further comprising generating at least a second set of templates for a second typeset or font.

7. The process according to claim 1, further comprising generating OCR-dependant input parameters from the templates and saving the input parameters on the media.

8. The process according to claim 1, further comprising deriving a look up table from the grid and saving the look up table on the media.

9. The process according to claim 1, wherein the step of using the templates in the optical character recognition algorithm comprises exporting the templates to an image coupon in image space prior to recognizing the characters contained in the marking.

10. The process according to claim 1, wherein the exporting step comprises resampling the templates to a matching resolution and zoom scale of the character.

11. The process according to claim 1, wherein the marking is a part marking on a component.

12. The process according to claim 1, wherein the component is a gas turbine engine component.

13. A system for training machine typesets for character recognition, the system comprising:
means for individually generating at least a first set of templates for each of a plurality of characters, each of the templates comprising a grid of cells and each template being generated by selecting certain cells of the grid to define a pattern that correlates to a corresponding one of the characters;
media adapted for saving information related to the shape of each template and from which the information can be retrieved;
means for regenerating the templates from the information; and
an optical character recognition algorithm adapted to use the templates to recognize at least some of the characters contained in a marking.

14. The system according to claim 13, wherein the generating means and media are components of an off-line system, and the optical character recognition algorithm is a component of an on-line system.

15. The system according to claim 13, wherein the generating means comprises a screen on which the grid is displayed and with which the cells can be selected.

16. The system according to claim 13, wherein the generating means is configured to generate the first set of the templates for a single typeset or font.

17. The system according to claim 16, wherein the generating means is configured to generate at least a second set of templates for a second typeset or font.

18. The system according to claim 13, further comprising a look up table derived from the grid and stored on the media.

19. The system according to claim 13, further comprising means for exporting the templates into image space prior to recognizing the characters contained in the marking.

20. The system according to claim 13, wherein the optical character recognition algorithm uses a correlation technique to compare an image of the marking against the templates to generate a digital manifestation of at least one character recognized from the marking.
